(19) United States
(12) Patent Application Publication
(10) Pub. No.: US 2014/0223435 A1
(43) Pub. Date: Aug. 7, 2014

(54) Virtual Machine Migration

(71) Applicant: Hangzhou H3C Technologies Co., LTD., Hangzhou, Zheijiang (CN)

(72) Inventor: Huifeng Chang, Haidian District (CN)

(21) Appl. No.: 14/346,324

(22) PCT Filed: Nov. 27, 2012
(86) PCT No.: PCT/CN2012/085321

§ 371 Date: Mar. 21, 2014

(30) Foreign Application Priority Data
Nov. 28, 2011 (CN) 201110385281.3

(51) Int. Cl. G06F 9/455

(52) U.S. Cl. CPC G06F 9/45533
USPC 718/1

(57) ABSTRACT

Methods and devices for migrating a virtual machine from a source server to a destination server. Information identifying a multicast group of the virtual machine on the source server is received. Before the virtual machine migrates to the destination server, a destination interface of a destination network device connected to the destination server is added to the identified multicast group such that the virtual machine continues to receive multicast traffic of the multicast group after the migration.

### BACKGROUND

Rapid growth in enterprise and cloud-based networking deployments has led to a significant increase in the complexity of Ethernet networking in data centers. Through virtualization, multiple virtual machines can be run on a physical server and these virtual machines can be migrated across physical servers located in geographically dispersed data centers.

### BRIEF DESCRIPTION OF DRAWINGS

Non-limiting example(s) will be described with reference to the following drawings, in which:

FIG. 1 is a block diagram of an example network for virtual machine migration;

FIG. 2 is a block diagram of an example forwarding model of IEEE 802.1Qbg Edge Virtual Bridging (EVB);

FIG. 3 is a flowchart of an example process for migration of a virtual machine from a source server to a destination physical server;

FIG. 4 is the block diagram of the FIG. 1 showing migration of a virtual machine according to a first example;

FIG. 5 is a flowchart of the first example process in FIG. 4;

FIG. 6 is the block diagram of the FIG. 1 showing migration of a virtual machine according to a second example;

FIG. 7 is a flowchart of a the second example process in FIG. 6;

FIG. 8 is an example structure of an extended virtual station interface (VSI) Discovery and Configuration Protocol (VDP);

FIG. 9 is the block diagram of the FIG. 1 showing migration of a virtual machine according to a third example;

FIG. 10 is a flowchart of a the third example process in FIG. 9;

FIG. 11 is an example structure of a server; and

FIG. 12 is an example structure of a network device.

### DETAILED DESCRIPTION

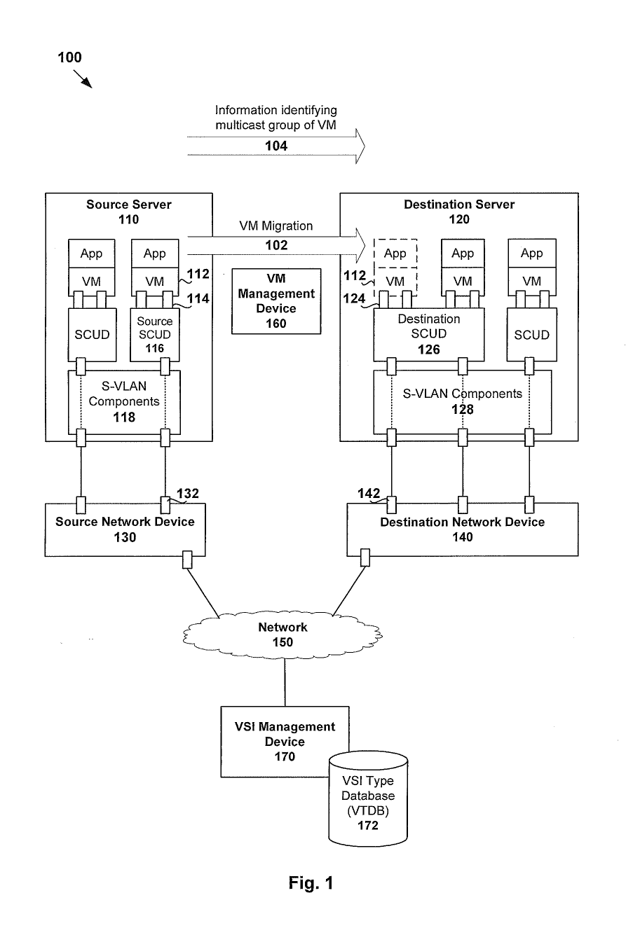

The present disclosure discusses methods and devices for migrating a virtual machine from a source server to a destination server. FIG. 1 is a block diagram of an example network 100 in which a virtual machine (VM) 112 hosted on a source physical server 110 is migrating to a destination physical server 120; see arrow generally indicated at 102. The VM may be a member (‘receiver’) of a multicast group. The present disclosure discusses a method by which the VM 112 may continue to receive multicast data of a particular multicast group even after it has migrated to the new destination.

According to one example, information identifying a multicast group of the VM 112 on the source server 110 is also “migrated” or “transferred” so that the VM 112 may continue to receive the multicast data after the migration; see arrow generally indicated at 104 in FIG. 1. The information identifying the multicast data is received, for example, by the destination server 120 or a destination network device 140 connected to the destination server 120. A destination interface 142 of the destination network device 140 connected to the destination server 120 is then added to the identified multicast group, before the VM 112 migrates to the destination server 120.

In this way, the VM 112 continues to receive multicast traffic of the multicast group after the migration. In some examples the VM 112 is able to receive multicast data as soon as, or very shortly after, it has been migrated, thereby minimising disruption. Throughout the present disclosure, the term “source” generally refers to the initial location of the virtual machine 112 from which it migrates, and “destination” and “target” both refer to the new location to which the virtual machine migrates.

In more detail, the source 110 and destination 120 servers are connected to a communications network 150 via a source network device 130 and a destination network device 140 respectively. The network device 130, 140 may be a switch, access switch, adjacent bridge, and edge bridge etc. Although separate source 130 and destination 140 network devices are shown in the example in FIG. 1, the source 110 and destination 120 physical servers may be connected to a common network device. In this case, the common network device acts as both the source 130 and destination 140 network devices. The communications network 150 may be a layer-2 (L2) network etc.

A software entity called hypervisor enables multiple virtual machines to share a common server by incorporating a Virtual Ethernet Bridge (VEB) and/or a Virtual Ethernet Port Aggregation (VEPA). VEB and VEPA are generally called S-Channel User Device (SCUD).

The virtual machine 112 supports one or more virtual network interface controllers (vNICs). Each vNIC is associated with a Virtual Station Interface (VSI) 114, 124, and different vNICs have different corresponding VSIs. The vNIC is connected to a SCUD 116, 126 through the VSI 114, 124. The SCUD associated with the virtual machine 112 on the source server 110 is referred to as a source SCUD 116, while a destination SCUD 126 is associated with the virtual machine 112 at the destination server 120.

Each SCUD 116, 126 is connected to an external network device 130, 140 via an S-Channel 132, 142. An S-Channel is a point-to-point S-Virtual Local Area Network (S-VLAN) that includes port-mapping S-VLAN components present in servers 110, 120 and network devices 130, 140. The end point of an S-Channel is called S-Channel Access Port (CAP). A frame is tagged with an S-tag when entering an S-Channel, and the S-tag is removed by the S-Channel components when the frame leaves the S-Channel.

In the example in FIG. 1, the S-VLAN components at the source 110 and destination 120 servers are indicated at 118 and 128 respectively. In this example, the external network devices 130, 140 connected to the servers 110, 120 are the source switch 130 and destination switch 140 respectively.

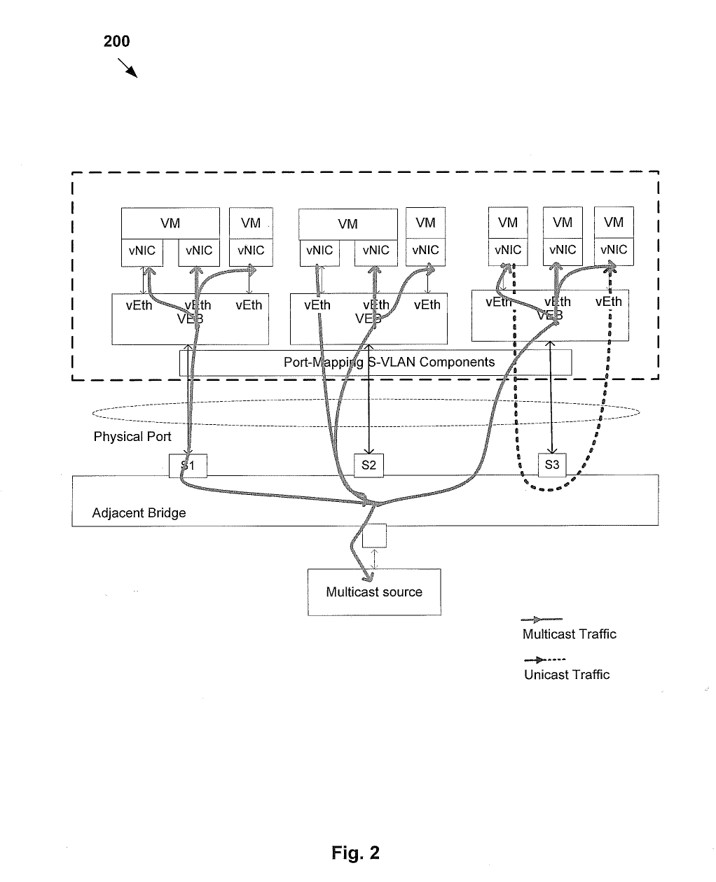

According to an example traffic forwarding model 200 of IEEE802.1Qbg Edge Virtual Bridging (EVB) model shown in FIG. 2, a physical port is divided into a plurality of S-Channels according to the S-VLAN tag. From a traffic forwarding perspective, each S-Channel is equivalent to an interface of a traditional switch. In this example, a single physical port supports three S-Channels S1, S2, and S3 that are treated in the same way as other physical ports on the forwarding level.

Edge Virtual Bridging (EVB) supports migration of virtual machines in the network 110. In the example in FIG. 1, virtual machine 112 migrates from the source SCUD 116 (say, SCUD A) at the source server 110 to a destination SCUD 126 (say, SCUD B) at the destination server 120. The corresponding S-Channels, (say S-Channel A and S-Channel B) may be located at different physical ports of the same switch or different switches 130, 140.

As shown in FIG. 1, the source and destination servers 110, 120 are also connected to various network management devices such as a VM management device 160 and VSI management device 170. The network management devices 160, 170 are deployed in the network 100 to support migration of the virtual machine 112.

The example network 100 in FIG. 1 supports multicasting applications such as Internet Protocol Television (IPTV), online video streaming, and gaming etc. Internet Group Management Protocol (IGMP) is a protocol in the TCP/IP protocol family for managing multicast group membership information that includes multicast entries (Source IP address S, multicast group address G).

Each virtual machine 112 in the network 100 may be a receiver of one or more multicast groups. The respective multicast sources (not shown) send multicast traffic to the virtual machines 112 via the communications network 150. Using IGMP snooping, a layer-2 device such as the source switch 130 is able to snoop or listen in to the IGMP conversations between virtual machines 112 and adjacent routers to establish a mapping relationship between a port and a medium access control (MAC) address.

### Virtual Machine Migration

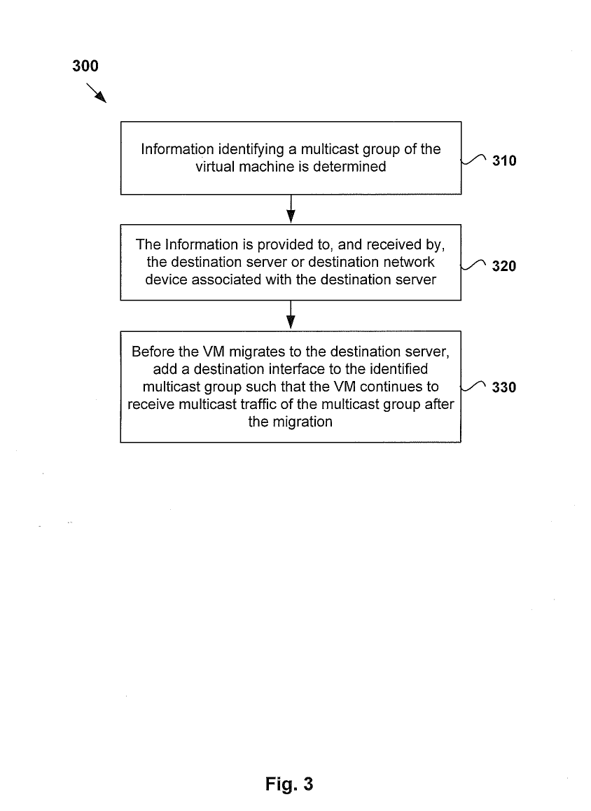

FIG. 3 is a flowchart of an example process for migration of a virtual machine 112 from a source server 110 to a destination server 120. According to one aspect, the example process includes the following:
At block 310, information identifying a multicast group of the virtual machine 112 on the source server 110 is determined. The information may be determined by the source server 110 or the source switch 130 (“second device”) associated with the source server 110. The information may also identify VSI corresponding to each multicast group. Any suitable processes such as IGMP snooping may be used.
At block 320, the information is provided to, and received by, the destination server 120 or a destination switch 140 associated with the destination server 120. The information may be transmitted or received via a network management device 160 or 170 that resides on the management side of the network.
At block 330, before the virtual machine migrates to the destination server 130, a destination interface 142 of the destination switch 140 is added to the identified multicast group such that the virtual machine 112 continues to receive multicast traffic of the multicast group after the migration. The destination interface 142 may be added to the multicast group by the destination switch 140 (“first device”).

According to the example process in FIG. 3, a destination interface 142 of the destination switch 140 is added to the multicast group before the virtual machine 112 migrates to the destination server 120. As such, after migrating to the destination interface, the virtual machine 112 is able to continue receiving multicast traffic of the multicast group without any interruption to the multicast traffic. The destination interface 142 is the interface through which the destination server 120 is connected to the destination switch 140.

For example in FIG. 1, virtual machine 112 is a multicast receiver of a multicast group, say G. Prior to the migration, the virtual machine 112 joins the multicast group using IGMP. Using IGMP snooping, the source switch 130 is able to capture IGMP join messages sent by the virtual machine 112 and adds an interface at the source switch 130 that is associated with the virtual machine 112 to the multicast group G.

According to the example process in FIG. 3, a destination interface at the destination switch 140 is added to the multicast group G before the virtual machine 112 migrates to the destination server 120. Advantageously, the virtual machine 112 continues to receive multicast traffic of the multicast group, and multicast traffic to the virtual machine 112 is not interrupted.

Otherwise, if the destination interface 142 is not added to the multicast group before the migration, the virtual machine 112 would have to send an IGMP membership report message in response to an IGMP query message from an IGMP querier after the migration. The destination switch 140 would then have to snoop the IGMP membership report message in order to add the destination interface 142 to the multicast group. However, since IGMP query messages are only sent periodically, there will be interruption to the multicast traffic, such as for tens of seconds, until the IGMP query message is received by the virtual machine 112 and the IGMP membership report message is sent in response.

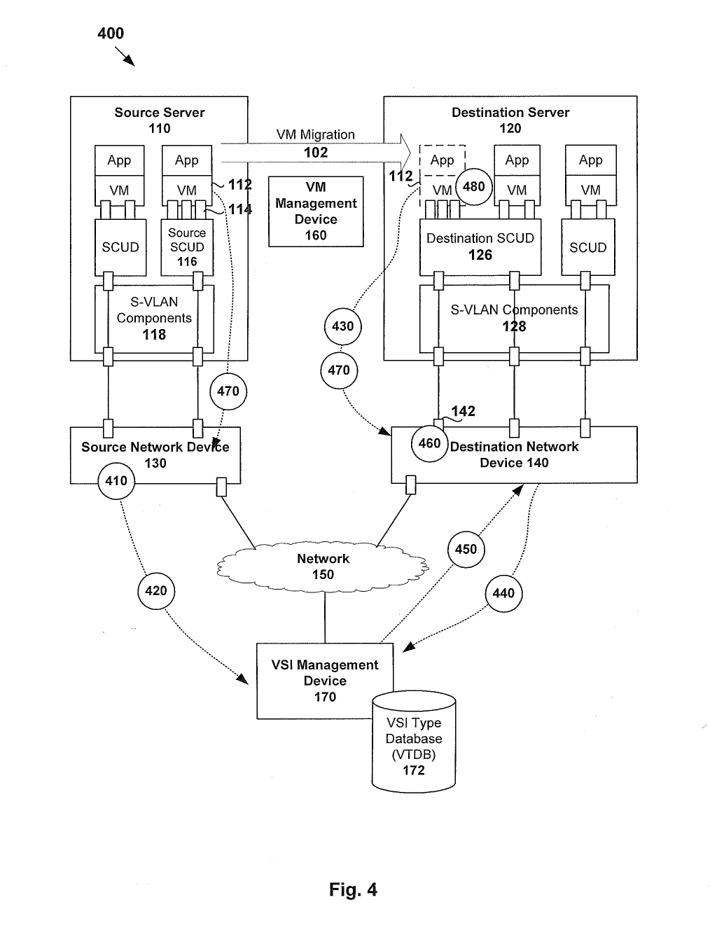

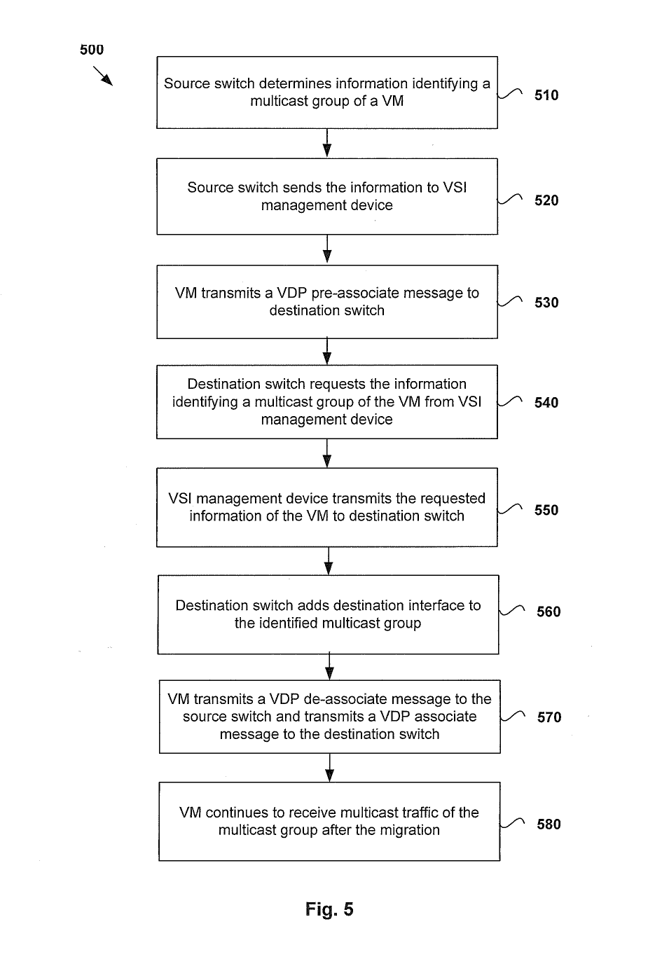

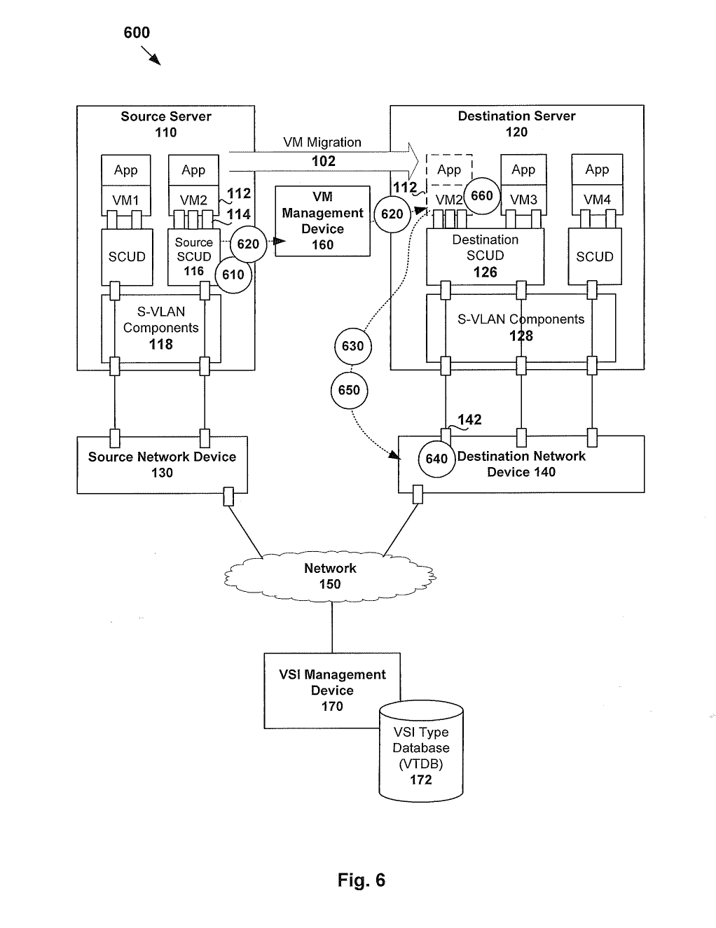

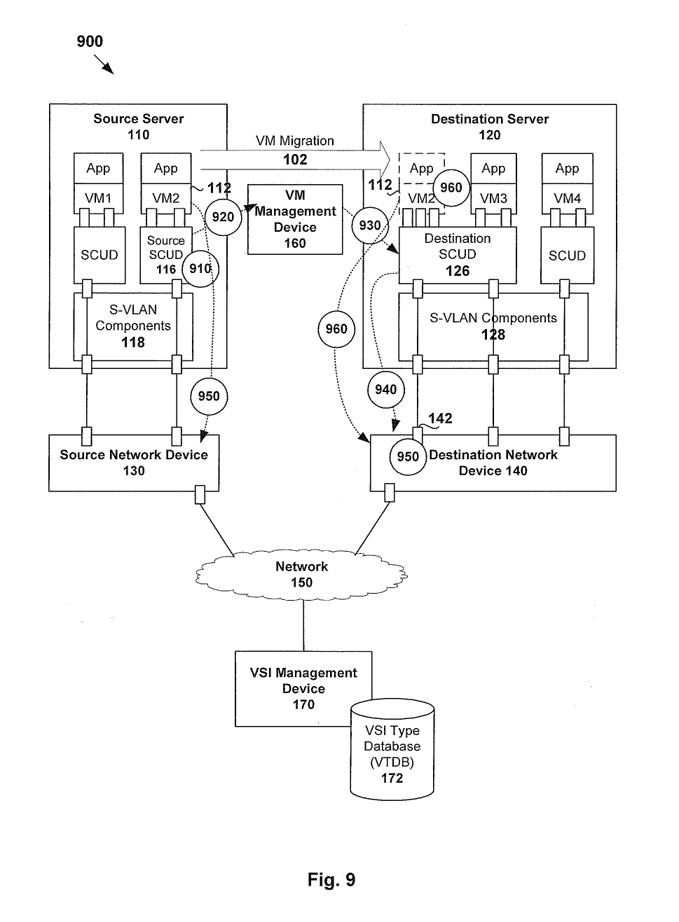

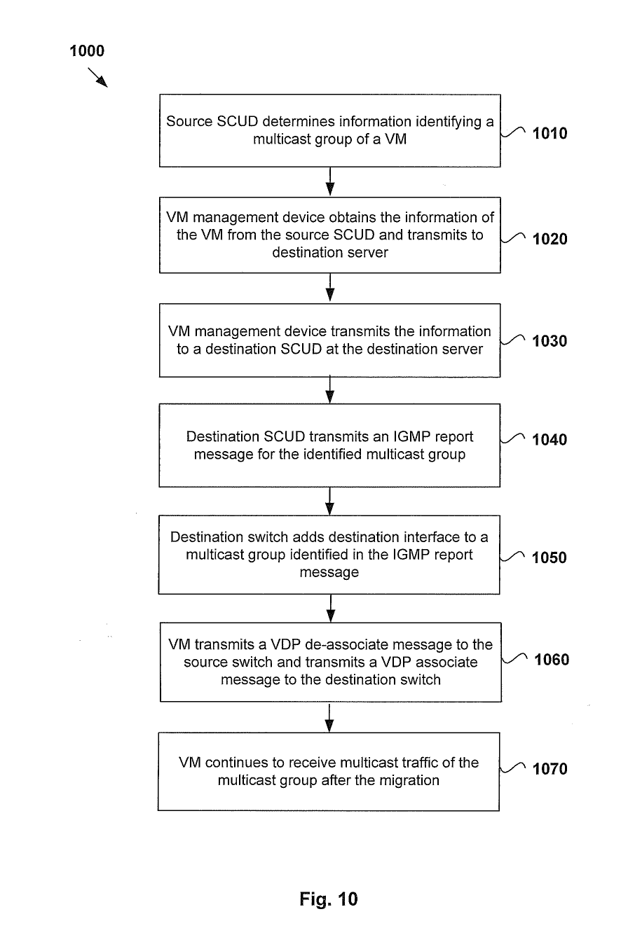

The example process in FIG. 3 will be now explained in more detail using the following examples:
Example 1 with reference to FIGS. 4 and 5, in which migration of the virtual machine 112 is facilitated by the source 110 and destination 120 servers; source 130 and destination 140 switches; and VSI management device 170;
Example 2 with reference to FIGS. 6, 7 and 8, in which migration of the virtual machine 112 is facilitated by the source 110 and destination 120 servers; VM management device 160 and destination switch 140; and
Example 3 with reference to FIGS. 9 and 10, in which migration of the virtual machine 112 is facilitated by the source 110 and destination 120 servers, VM management device 160 and destination switch 140.

According to Examples 1 to 3, before virtual machine 112 migrates to the destination server 120, the destination interface 142 at the destination switch 140 is controlled to join one or more multicast groups of which the virtual machine 112 is a member. Although VM2 is used as the migrating virtual machine 112 in Examples 1 to 3, it will be appreciated that other virtual machines 112 may migrate in a similar manner.

### EXAMPLE 1

FIG. 4 is the block diagram of the example network in FIG. 1 showing information flows and processes according to the flowchart in FIG. 5 when the virtual machine 112 migrates from the source server 110 to the destination server 120.

(a) Information identifying one or more multicast groups of the virtual machine 112 on the source server is determined according to block 310 in FIG. 3:
At 410 in FIG. 4 and 510 in FIG. 5, the source switch 130 of the virtual machine 112 runs IGMP snooping to snoop one or more IGMP membership report messages transmitted by the virtual machine 112.
Based on the Virtual Local Area Network (VLAN) and source Medium Access Control (MAC) address in a snooped IGMP membership report message, the source switch 130 identifies information identifying to one or more multicast groups of the virtual machine 112 on the source server 110 (also known as the “source virtual machine”).
The information may include the VSI 114 of the source server 110 that corresponds to each multicast group. The information is also referred to as “VSI-multicast group information”. For example, if the virtual machine 112 supports three VSIs (say VSI 1, VSI 2 and VSI 3) and is a member of three multicast groups, the VSI-multicast group information includes the following entries:

TABLE 1

| VSI | Multicast group |
|---|---|
| VSI 1 | (S-A, G-A) |
| VSI 2 | (S-B, G-B) |
| VSI 3 | (S-C, G-C) |

(b) The information is provided to, and received by, the destination switch 140 connected with the destination server 120 according to block 320 in FIG. 3:
At 420 in FIG. 4 and 520 in FIG. 5, the source switch 130 reports the information determined at block 410 to a VSI management device 170. In this case, the VSI management device 170 is the network management device responsible for managing the information. The information is stored in a VSI type database (VTDB) 172.
In one example, the source switch 130 also stores the information in a local table at the source switch 130. The local table is updated every time the source switch 130 learns a VSI joining and/or leaving a multicast group. The updated information is then sent to the VSI management device 170 in real time, which then updates the VTDB accordingly.
Using Table 1 as an example, when the source switch 130 is informed of VSI 1 leaving multicast group (S-A, G-A), the corresponding entry is removed. Once updated, the VSI management device 170 also removes the corresponding entry in the VTDB.
At 430 in FIG. 4 and 530 in FIG. 5, when preparing for migration, the VM management device 160 controls the virtual machine 112 at the destination server 120 to transmit a VSI Discovery and Configuration Protocol (VDP) pre-associate message to the destination switch 140.
At 440 in FIG. 4 and 540 in FIG. 5, after receiving the VDP pre-associate message, the destination switch 140 requests the information identifying one or more multicast groups of the virtual machine 112 from the VSI management device 170.
At 450 in FIG. 4 and 550 in FIG. 5, after receiving the request from the destination switch 140, the VSI management device 170 retrieves the information identifying the multicast groups of the virtual machine 112 from the VTDB 172 and transmits the information to the destination switch 140. For example, the information includes information relating to the multicast group that corresponds to VSI 1 is set out in Table 2.

TABLE 2

| | |
|---|---|
| VSI | (S-A, G-A) |

(c) A destination interface 142 at the destination switch 140 is added to one or more multicast groups of the virtual machine 112 before the migration according to block 330 in FIG. 3:
At 460 in FIG. 4 and 560 in FIG. 5, after receiving the information identifying the multicast groups of the virtual machine 112, the destination switch 140 adds a destination interface 142 of the destination switch 140 to each of the multicast groups.
In one example, the destination switch 140 enables a function called “IGMP snooping simulated joining” or “IGMP snooping simulated host joining” on the destination interface 142 to add the destination interface to the multicast group.
In general, a host running IGMP responds to a query message from an IGMP querier. If the host is unable to respond for some reasons, a multicast router might assume that a multicast group does not have any members, and therefore removes the corresponding forwarding path. To prevent this, an interface of a switch is configured as a member of the multicast group, namely configuring the interface as a “simulated member host”. The simulated member host responds to any IGMP query messages to ensure that the switch can continue to receive multicast messages.
The process of a simulated host joining a multicast group is as follows:
   When enabling simulated joining on a destination interface 142, the destination switch 140 transmits an IGMP membership report message via the interface 142.
   After simulated joining is enabled on the destination interface 142, if an IGMP general group query message is received, the destination switch 140 responds with an IGMP membership report message via the interface 142. And,
   When disabling simulated joining on the destination interface 142, the destination switch 140 will transmit an IGMP leave group message via the interface 142.
By enabling IGMP snooping simulated joining, the destination interface 142 is added to the identified multicast groups of the virtual machine 112. This ensures that the virtual machine 112 continues to receive multicast traffic of each multicast group after migration. Using VSI 1 as an example, after receiving the information in Table 2, IGMP snooping simulated joining is enabled to add the interface (destination interface 142 of the destination switch 140) to the multicast group (S-A G-A).
At 470 in FIG. 4 and 570 in FIG. 5, when the virtual machine 112 migrates formally from the source server 110 to the destination server 120, the virtual machine 112 on the source server 110 transmits a VDP de-associate message to the source switch 120, and the virtual machine 112 on the destination server 120 sends a VDP associate message to the destination switch 140.
At 480 in FIG. 4 and 580 in FIG. 5, after successfully migrating to the destination server 120, the virtual machine 112 continues to receive multicast traffic of the multicast groups (S-A, G-A), (S-B, G-B) and (S-C, G-C) in Table 1 without any interruption.

According to Example 1, the destination interface 142 joins the multicast group of the virtual machine 112 before the latter migrates to the destination server 120, and therefore, the destination interface 142 of the destination switch 140. As such, the virtual machine 112 is able to continue to receive multicast traffic of the multicast groups after the migration, and multicast traffic is not interrupted.

It will be appreciated that, at 440 and 540, the destination switch 140 may request for the information from the VSI management device 170 after receiving the VDP associate message, instead of the VDP pre-associate message. In both cases, the destination switch 140 adds the destination interface 142 to the multicast group such that the virtual machine 112 continues to receive the multicast traffic after the migration via the destination interface 142.

### EXAMPLE 2

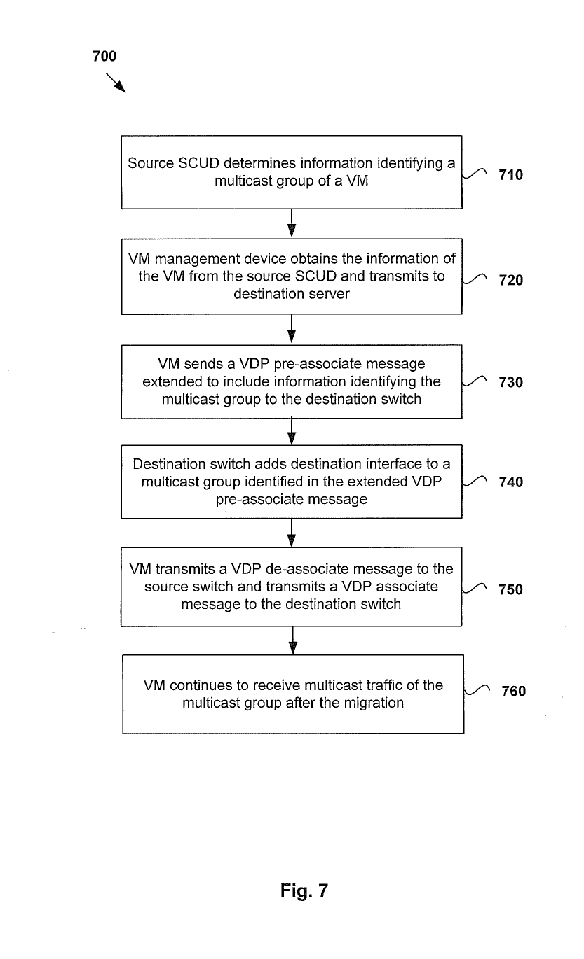

FIG. 6 is the block diagram of the example network in FIG. 1 showing information flows and processes according to the flowchart in FIG. 7 when the virtual machine 112 migrates from the source server 110 to the destination server 120.

Unlike Example 1, a source SCUD 116 associated with the virtual machine 112 identifies the VSI-multicast group information of the virtual machine 112 instead of the source switch 130.

(a) Information identifying one or more multicast groups of the virtual machine 112 is determined according to block 310 in FIG. 3:
At 610 in FIG. 6 and 710 in FIG. 7, the source SCUD 116 at the source server 110 hosting the virtual machine 112 determines the information identifying one or more multicast groups of the virtual machine 112.
In one example, IGMP snooping is used. When an IGMP membership report message from the virtual machine 112 is snooped, the source SCUD 116 determines the VSI of the virtual machine 112 that corresponds to a multicast group in the IGMP report message. Since the virtual machine 112 is connected to the source SCUD 116 through a VSI 114, the VSI 114 through which the IGMP report message is received is the VSI that corresponds to the multicast group associated with the IGMP report message.
The information is also referred to as VSI-multicast group information. Consider an example where a virtual machine 112 is a member of two multicast groups and supports VSI 1 and VSI 2, the source SCUD 116 determines the following information of the virtual machine 112 using IGMP snooping:

TABLE 3

| VSI | Multicast group |
|---|---|
| VSI 1 | (S-A, G-A) |
| VSI 2 | (S-B, G-B) |

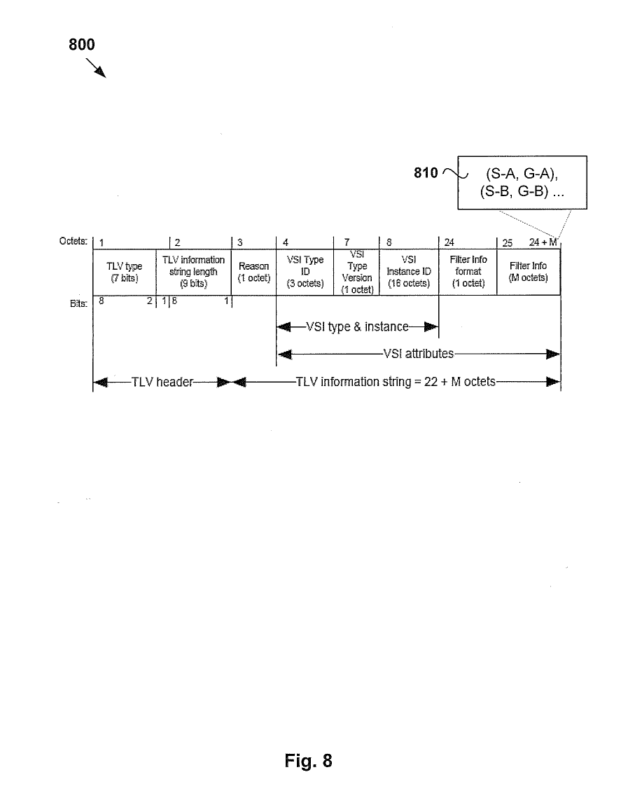

(b) The information identifying one or more multicast groups of the virtual machine 112 is provided to, and received by, the destination server 120 according to block 320 in FIG. 3:
At 620 in FIG. 6 and 720 in FIG. 7, when the virtual machine 112 prepares for migration, the information determined at 610 and 710 is retrieved by the VM management device 160 from the source SCUD 116. The retrieved information is then sent to the virtual machine 112 at the destination server 120. The VM management device 160 controls the migration of the virtual machine 112.
At 630 in FIG. 6 and 730 in FIG. 7, the VM management device 160 controls the pre-association of the virtual machine 112 with the destination switch 140. In particular, the VM management device 160 controls the virtual machine 112 at the destination server 120 to transmit an extended VDP pre-associate message to the destination switch 140.
Referring to FIG. 8, the VDP pre-associate message is extended to include information identifying the multicast groups of the virtual machine 112. In the example structure in FIG. 8, the extended pre-associate message identifies 810 multicast groups (S-A, G-A) and (S-B, G-B) of the virtual machine 112.

(c) A destination interface 142 at the destination switch 140 is added to one or more multicast groups of the virtual machine 112 before the migration according to block 330 in FIG. 3:
At 640 in FIG. 6 and 740 in FIG. 7, after receiving the extended VDP pre-associate message, the destination switch 140 adds a destination interface 142 to the multicast groups identified in the received VDP pre-associate message. In one example, the destination switch 140 enables IGMP snooping simulated joining on the destination interface 142 to add the destination interface to the multicast groups. This is similar to 460 and 560 in Example 1.
At 650 in FIG. 6 and 750 in FIG. 7, when the virtual machine 112 migrates formally from the source server 110 to the destination server 120, the virtual machine 112 transmits a VDP de-associate message to the source switch 120 and a VDP associate message to the destination switch 140, 650 and 750 are similar to 470 and 570 in Example 1 respectively.
At 660 in FIG. 6 and 760 in FIG. 7, after successfully migrating to the destination server 120, the virtual machine 112 continues to receive multicast traffic of the multicast groups (S-A, G-A) and (S-B, G-B) in Table 3. 660 and 760 are similar to 480 and 580 in Example 1 respectively.

According to Example 2, the extended VDP pre-associate message includes the multicast group information corresponding to the VSI of the virtual machine 112. In another example implementation, the information identifying the multicast groups of the virtual machine 112 may be included in the VDP associate message, instead of the VDP pre-associate message, at 650 and 750. In this case, the VDP associate message is extended in a similar manner to carry the multicast group information.

According Example 1 and Example 2, the destination switch 140 enables IGMP Snooping simulated joining on the destination interface 142 in order to add the destination interface 142 to the identified multicast groups. However, it is not necessary for the destination interface 142 to always have the IGMP Snooping simulated joining enabled.

For example, if the destination interface 142 receives the first IGMP report message or IGMP leave message, or after a predetermined period, the IGMP snooping simulated joining function is disabled and IGMP snooping enabled to manage multicast traffic forwarding. A timer may also be set to disable IGMP report message or IGMP leave message and enable IGMP snooping once it expires after a predetermined period.

### EXAMPLE 3

FIG. 9 is the block diagram of the example network in FIG. 1 showing information flows and processes according to the flowchart 1000 in FIG. 10 when the virtual machine 112 migrates from the source server 110 to the destination server 120.

In this case, compared to Example 1 and Example 2, before the virtual machine 112 successfully migrates to the destination server 120, the VM management device 160 transmits the information identifying one or more multicast groups of the virtual machine 112 to its associated destination SCUD 126 at the destination server 120. The destination interface 142 is then added to the identified multicast groups based on an IGMP report message transmitted by the destination SCUD 126.

(a) Information identifying one or more multicast groups of the virtual machine 112 on the source server 110 is determined according to block 310 in FIG. 3:
At 910 in FIG. 9 and 1010 in FIG. 10, the source SCUD 116 at the source server 110 hosting the virtual machine 112 determines the information identifying one or more multicast groups of the virtual machine 112.
Similar to 610 in FIG. 6 and 710 in FIG. 7, IGMP snooping may be used. When an IGMP report message from the virtual machine 112 is snooped, the source SCUD 116 determines the multicast group in the IGMP report message, and its corresponding VSI of the virtual machine 112. Since the virtual machine 112 is connected to the source SCUD 116 through a VSI 114, the VSI 114 through which the IGMP report message is received is the VSI that corresponds to the multicast group associated with the IGMP report message.
Consider an example where a virtual machine 112 supports VSI 1 and VSI 2, the source SCUD 116 obtains the following:

TABLE 4

| VSI identifier | Multicast group |
|---|---|
| VSI 1 | (S-A, G-A) |
| VSI 1 | (S-B, G-B) |
| VSI 2 | (S-C, G-C) |

(b) The information identifying one or more multicast groups of the virtual machine 112 is provided to, and received by, the destination server 120 according to block 320 in FIG. 3:
At 920 in FIG. 9 and 1020 in FIG. 10, the VM management device 160 controls the migration of the virtual machine 112. When the virtual machine 112 prepares for migration, the VM management device 160 retrieves the information determined at 910 and 1010 from the source SCUD 116.
At 930 in FIG. 9 and 1030 in FIG. 10, before the virtual machine 112 migrates to the destination server 120, the VM management device 160 distributes the retrieved information to a destination SCUD 126 at the destination server 120. The destination SCUD 126 is the SCUD associated with the virtual machine 112 at destination server 120.
At 940 in FIG. 9 and 1040 in FIG. 10, the VM management device 160 controls the destination SCUD 126 to transmit an IGMP report message for an identified multicast group. The purpose is to add the destination interface 142 of the destination switch 140 to the multicast group.
For example, for VSI 1, the destination SCUD 126 controlled by the VM management device 160 transmits IGMP report messages for multicast groups G-A and G-B respectively, such that the destination interface 142 of the destination switch 140 is added to multicast groups G-A and G-B.

(c) A destination interface 142 at the destination switch 140 is added to one or more multicast groups of the virtual machine 112 before the migration according to block 330 in FIG. 3:
At 950 in FIG. 9 and 1050 in FIG. 10, after receiving the IGMP report messages, the destination switch 140 adds a destination interface 142 to the multicast groups identified in the IGMP report messages. For example, for VSI 1, the destination interface 142 of the destination switch 140 is added to multicast groups G-A and G-B.
At 960 in FIG. 9 and 1060 in FIG. 10, when the virtual machine 112 migrates formally from the source server 110 to the destination server 120, the virtual machine 112 transmits a VDP de-associate message to the source switch 120 and a VDP associate message to the destination switch 140. This is similar to 650 and 750 in Example 2, and 470 and 570 in Example 1.
At 970 in FIG. 9 and 1070 in FIG. 10, after successfully migrating to the destination server 120, the virtual machine 112 continues to receive multicast traffic of the multicast groups (S-A, G-A), (S-B, G-B) and (S-C, G-C) in Table 4. This is similar to 660 and 760 in Example 2, and 480 and 580 in Example 1.

It should be understood that, in Examples 1 to 3, the VSI management device 170 may be replaced by other network management devices. Similarly, the VM management device 160 may be replaced by other network management devices.

Example Structures

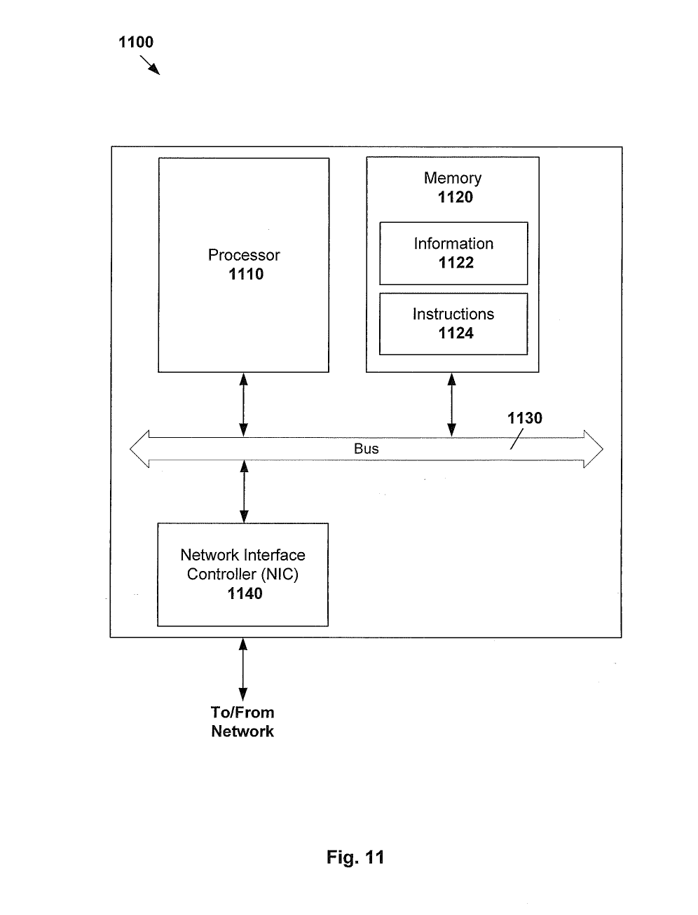

FIG. 11 shows a block diagram of an example server 1100 capable of acting as a source server 110 and a destination server 120. The example server 1100 includes a processor 1110, a memory 1120 and a network interface device 1130 that communicate with each other via a bus 1130.

The processor 1110 is capable of implementing relevant processes performed by a source server 110 as explained with reference to FIGS. 3 to 10. At a source server 110 (“second device”) according to Examples 1, 2 and 3, the processor 1110 is to perform the following:
Determine information identifying a multicast group of the virtual machine 112 on the source server 110, such as using IGMP snooping.
Before the virtual machine migrates to the destination server 120, provide the information to a network management device 160, 170 for transmission to a destination network device 140 connected to the destination server. This is to add a destination interface 142 of the destination network device 140 to the identified multicast group and the virtual machine 112 continues to receive multicast traffic of the multicast group after the migration.

The processor 1110 is capable of implementing relevant processes performed by a destination server 110 as explained with reference to FIGS. 3 to 10. For example:

(a) According to Example 1 in FIGS. 4 to 5, the processor 1110 at a destination server 120 is to control the virtual machine 112 at the destination server 120 to:
Transmit VDP pre-associate and associate messages to the destination network device 140.

(b) According to Example 2 in FIGS. 6 to 8, the processor 1110 of the destination server 120 is to control the virtual machine 112 at the destination server 120 to:
Receive the information identifying a multicast group of the virtual machine 112 from the source server 110 via the VM management device.
Transmit a VDP pre-associate or associate message extended to include the information identifying the multicast group to the destination network device 140.

(c) According to Example 3 in FIGS. 9 and 10, the processor 1110 at a destination server 120 is to control a destination SCUD 126 at the destination server 120 to:
Receive the information identifying a multicast group of the virtual machine 112 from the source server 110 via the VM management device.
Transmit an IGMP report message that identifies the multicast group of the virtual machine 112 to the destination network device 140.

Relevant information 1122, such as information identifying the multicast groups of the virtual machine 112, is stored in the memory 1120. Machine executable instructions to cause the processor 1110 to perform the relevant processes in FIGS. 3 to 10 are also stored in the memory.

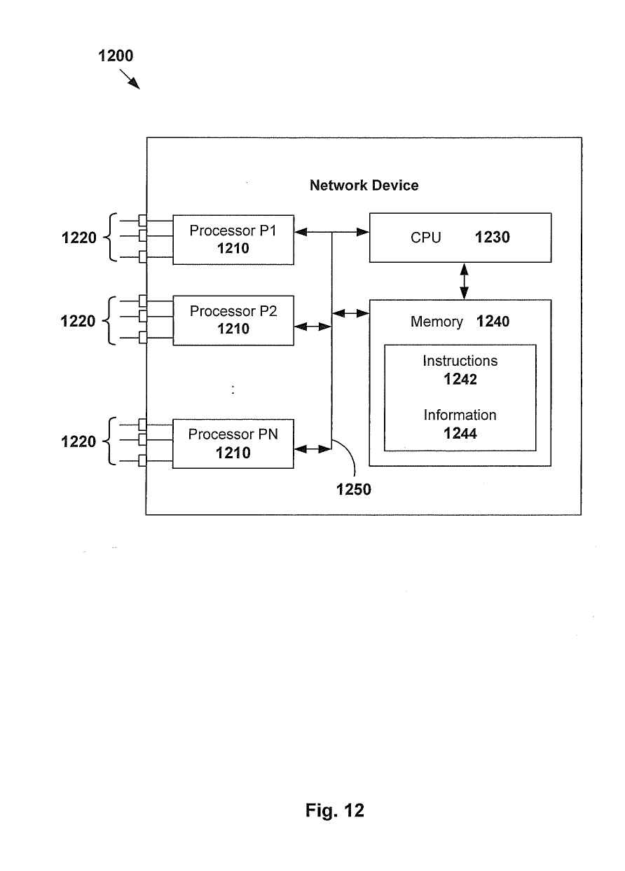

FIG. 12 is a block diagram of an example network device 1200 capable of acting as a source network device 130 and destination network device 140.

The network device 1200 includes one or more sub-processors 1210 (labelled P1 to PN) that are each connected to a subset of interfaces or ports 1220. The sub-processors 1210 are interconnected to each other via internal paths 1250, and connected to a central processing unit (CPU) 1230 and memory 1240. Each sub-processor 1210 may be connected to any number of ports 1220, and this number may vary from one processor 1210 to another.

The CPU 1230 is a type of processor that programs the sub-processors 1210 with machine-readable instructions 1242 to facilitate migration of a virtual machine 112 according to the relevant processes in FIGS. 3 to 10. The machine-readable instructions 1242 are stored in the memory 1240. Other information required for virtual machine migration, such as the VSI-multicast group information in Tables 1 to 4, is also stored in the memory 1240.

The internal paths 1250 may be a switching fabric embodied in a custom semiconductor integrated circuit (IC), such as an application-specific integrated circuit (ASIC), application specific standard product (ASSP) or field programmable gate array (FPGA) semiconductor device.

At a destination network device 140 (“first device”), the CPU 1230 is capable of implementing relevant processes as explained with reference to FIGS. 3 to 10. For example, the CPU 1230 of the destination network device 140 is to:
Receive information identifying a multicast group of the virtual machine 112 on the source server 110.
Before the virtual machine 112 migrates to the destination server 120, add a destination interface 142 of a destination network device 140 connected to the destination server 120 to the identified multicast group such that the virtual machine 112 continues to receive multicast traffic of the multicast group after the migration.

Referring now to Examples 1 to 3:

(a) According to Example 1 in FIGS. 4 to 5, the CPU 1230 of the destination network device 140 is to:
Retrieve the information from a virtual station interface (VSI) network management device after receiving a VDP pre-associate or associate message from the destination server 120. The information may also identify a VSI 114 of the source server 110 that corresponds to the multicast group.
Enable an Internet Group Management Protocol (IGMP) snooping simulated joining function at the destination network device 140 to add the destination interface 142 to the identified multicast group.
Disable the Internet Group Management Protocol (IGMP) snooping simulated joining function after the destination interface 142 receives an Internet Group Management Protocol (IGMP) report or leave message, or after a predetermined period of a timer expires.

(b) According to Example 2 in FIGS. 6 to 8, the CPU 1230 of the destination network device 140 is to:
Receive a VDP pre-associate or associate message that identifies the multicast group of the virtual machine. See also FIG. 8.
Enable an Internet Group Management Protocol (IGMP) snooping simulated joining function at the destination network device 140 to add the destination interface 142 to the identified multicast group.
Disable the Internet Group Management Protocol (IGMP) snooping simulated joining function after the destination interface 142 receives an Internet Group Management Protocol (IGMP) report or leave message, or after a predetermined period of a timer expires.

(c) According to Example 3 in FIGS. 9 to 10, the CPU 1230 of the destination network device 140 is to:
Receive an IGMP membership report message that identifies the multicast group of the virtual machine 112 from an S-Channel User Device (SCUD) 126 associated with the virtual machine 112 at the destination server 120.
Add the destination interface 142 of the destination network device 140 to the multicast group identified in the IGMP membership report message.

At a source network device 130, the CPU 1230 is capable of implementing relevant processes as explained with reference to FIGS. 3 to 10. According to Example 1 in FIGS. 4 to 5, the CPU 1230 of the source network device 130 is to:
Determine information identifying a multicast group of the virtual machine 112 on the source server 110, such as using IGMP snooping.
Before the virtual machine migrates to the destination server 120, provide the information to a network management device 160, 170 for transmission to a destination network device 140 connected to the destination server. This is to add a destination interface 142 of the destination network device 140 to the identified multicast group and the virtual machine 112 continues to receive multicast traffic of the multicast group after the migration.

The methods, processes and functional units described herein may be implemented by hardware (including hardware logic circuitry), software or firmware or a combination thereof. The term ‘processor’ is to be interpreted broadly to include a processing unit, ASIC, logic unit, or programmable gate array etc. The processes, methods and functional units may all be performed by the one or more processors; reference in this disclosure or the claims to a ‘processor’ should thus be interpreted to mean ‘one or more processors’.

Further, the processes, methods and functional units described in this disclosure may be implemented in the form of a computer software product. The computer software product is stored in a storage medium and comprises a plurality of instructions for making a processor to implement the processes recited in the examples of the present disclosure.

The figures are only illustrations of an example, wherein the units or procedure shown in the figures are not necessarily essential for implementing the present disclosure. Those skilled in the art will understand that the units in the device in the example can be arranged in the device in the examples as described, or can be alternatively located in one or more devices different from that in the examples. The units in the examples described can be combined into one module or further divided into a plurality of sub-units.

Although the flowcharts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

According to another aspect, there is also provided an example process for not interrupting traffic based on VM migration, which includes:
A. Identifying virtual station interface VSI multicast group information of a VM in a network by using Internet Group Management Protocol IGMP Snooping.
B. Transmitting the VSI multicast group information of the VM to the network management side.
C. Obtaining the VSI multicast group information of the VM from the network management side. Before the VM migrates to a destination interface of a destination switch, adding the destination interface into a multicast group corresponding to the obtained VSI multicast group information so that the VM continues to receive multicast traffic of said VSI multicast group after migrating to the destination interface.

According to yet another aspect, there is also provided an apparatus for not interrupting traffic based on virtual machine VM migration, characterized in that: said apparatus comprises:
An identification unit to identify virtual station interface VSI multicast group information of a VM in a network by running Internet Group Management Protocol IGMP Snooping.
A transmission unit to transmit the VSI multicast group information to the network management side.
A multicast group add-in unit to obtain the VSI multicast group information of the VM from the network management side before the VM migrates to a destination interface of a destination switch, adding the destination interface into a multicast group corresponding to the obtained VSI multicast group information so that the VM continues to receive multicast traffic of said VSI multicast group after migrating to the destination interface.

It will be appreciated that numerous variations and/or modifications may be made to the processes, methods and functional units as shown in the examples without departing from the scope of the disclosure as broadly described. The examples are, therefore, to be considered in all respects as illustrative and not restrictive.

1. A method for migrating a virtual machine from a source server to a destination server, the method comprising:
receiving information identifying a multicast group of the virtual machine on the source server; and
before the virtual machine migrates to the destination server, adding a destination interface of a destination network device connected to the destination server to the identified multicast group such that the virtual machine continues to receive multicast traffic of the identified multicast group after the migration.

2. The method of claim 1, wherein the information identifying the multicast group of the virtual machine also identifies a virtual station interface (VSI) of the source server that corresponds to the multicast group.

3. The method of claim 2, wherein receiving the information identifying the multicast group of the virtual machine comprises:
after receiving a virtual station interface discovery and configuration protocol (VDP) pre-associate or associate message from the destination server, retrieving the information from a virtual station interface (VSI) network management device.

4. The method of claim 1, wherein receiving the information comprises receiving a virtual station interface discovery and configuration protocol (VDP) pre-associate or associate message that identifies the multicast group of the virtual machine.

5. The method of claim 1, wherein adding the destination interface further comprises enabling an Internet Group Management Protocol (IGMP) snooping simulated joining function at the destination network device to add the destination interface to the identified multicast group.

6. The method of claim 5, wherein the Internet Group Management Protocol (IGMP) snooping simulated joining function is disabled after the destination interface receives an Internet Group Management Protocol (IGMP) report or leave message, or after a predetermined period of a timer expires.

7. The method of claim 1, wherein receiving the information comprises receiving an Internet Group Management Protocol (IGMP) membership report message that identifies the multicast group of the virtual machine from an S-Channel User Device (SCUD) associated with the virtual machine at the destination server.

8. The method of claim 7, wherein adding the destination interface further comprises adding the destination interface of the destination network device to the multicast group identified in the Internet Group Management Protocol (IGMP) membership report message.

9. A method for migrating a virtual machine from a source server to a destination server, the method comprising:
determining information identifying a multicast group of the virtual machine on the source server; and
providing the information to a network management device for transmission to a destination network device connected to the destination server, such that before the virtual machine migrates to the destination server, a destination interface of the destination network device is added to the identified multicast group and the virtual machine continues to receive multicast traffic of the multicast group after the migration.

10. The method of claim 9, wherein determining the information identifying the multicast group of the virtual machine further comprises using Internet Group Management Protocol (IGMP) snooping to snoop an IGMP membership report message from the virtual machine.

11. The method of claim 10, wherein the information identifying the multicast group of the virtual machine includes a virtual station interface corresponding to the multicast group, and the virtual station interface is determined based on a virtual local area network (VLAN) and a source medium access control (MAC) address in the snooped IGMP membership report message.

12. The method of claim 9, wherein the method is performed at an S-Channel User Device (SCUD) associated with the virtual machine on the source server, and the information is provided to a virtual machine (VM) network management device for transmission to the destination network device via the destination server.

13. The method of claim 9, wherein the method is performed at a source network device associated with the source server, and the information is provided to a virtual station interface (VSI) network management device for transmission to the destination network device.

14. A first device for migrating a virtual machine from a source server to a destination server, comprising a processor to:
receive information identifying a multicast group of the virtual machine on the source server; and
before the virtual machine migrates to the destination server, add a destination interface of a destination network device connected to the destination server to the identified multicast group such that the virtual machine continues to receive multicast traffic of the identified multicast group after the migration.

15. A second device for migrating a virtual machine from a source server to a destination server, comprising a processor to:
determine information identifying a multicast group of the virtual machine on the source server; and
provide the information to a network management device for transmission to a destination network device connected to the destination server, such that before the virtual machine migrates to the destination server, a destination interface of the destination network device is added to the identified multicast group and the virtual machine continues to receive multicast traffic of the multicast group after the migration.
